(19) United States
(12) Patent Application Publication
(10) Pub. No.: US 2012/0062451 A1
(43) Pub. Date: Mar. 15, 2012

(54) LIQUID CRYSTAL DISPLAY DEVICE

(76) Inventors: Katsuhiko Morishita, Osaka (JP); Tsuyoshi Okazaki, Osaka (JP); Takenhiko Sakai, Osaka (JP); Dai Chiba, Osaka (JP); Tetsuo Fujita, Osaka (JP); Kazunori Morimoto, Osaka (JP)

(21) Appl. No.: 13/319,399

(22) PCT Filed: Apr. 20, 2010
(86) PCT No.: PCT/JP2010/057016

§ 371 Date: Nov. 8, 2011

(30) Foreign Application Priority Data
May 13, 2009 (JP) 2009-116786
Jan. 15, 2010 (JP) 2010-006696

(51) Int. Cl. G09G 3/36

(52) U.S. Cl. 345/87

(57) ABSTRACT

The present invention provides a liquid crystal display device that allows suppressing loss of display quality caused by additional capacitance. The present invention provides a liquid crystal display device provided with a first substrate and a second substrate disposed opposing each other, and a liquid crystal layer sandwiched between the first substrate and the second substrate, wherein the first substrate has a gate bus line, a source bus line, a pixel electrode to which an image signal is inputted, and a common electrode to which a common signal is inputted, the pixel electrode and the common electrode are comb-shaped within a pixel, an electric field parallel to the surface of the first substrate is generated between the pixel electrode and the common electrode within the pixel, and the common electrode is arranged, within a display area, at a layer that is different from a layer at which the gate bus line is formed and from a layer at which the source bus line is formed.

### TECHNICAL FIELD

The present invention relates to a liquid crystal display device. More specifically, the present invention relates to a liquid crystal display device that is suitable for active matrix-type liquid crystal display devices.

### BACKGROUND ART

Active matrix-type liquid crystal display devices that use active elements, typified by thin film transistors (TFTs) are widely used as display devices on account of their thin profile, light weight and high image quality, comparable to that of CRTs.

Display modes in active matrix-type liquid crystal display devices include broadly two types, as follows.

In one mode, a liquid crystal layer is sealed between a pair of substrates on which respective transparent electrodes are formed, and a driving voltage is applied across the two transparent electrodes, to drive the liquid crystal layer by way of an electric field in a direction substantially at right angles with the substrate interfaces, so that light that passes through one of the transparent electrodes and that strikes the liquid crystal layer is modulated to elicit display as a result (hereafter also referred to as vertical electric field mode).

In active matrix-type liquid crystal display devices that rely on a vertical electric field mode, however, brightness changes are significant upon modification of the viewing angle direction. In particular, the gray scale level may become inverted depending on the viewing angle direction, in particular when gradation display is carried out.

In another mode, a liquid crystal layer is sealed between a pair of substrates, and a driving voltage is applied across two electrodes formed on one substrate or on both substrates. As a result, the liquid crystal layer is driven by a electric field that is substantially parallel to the substrate interface, and light that strikes the liquid crystal layer through a gap between the two electrodes is modulated, to elicit display as a result (hereafter, also referred to as transverse electric field mode).

Known liquid crystal modes in transverse electric field modes include, for instance, IPS (In-plane Switching) mode, TBA (Transverse Bend Alignment) mode and the like.

In all such modes, the liquid crystal layer is driven by a transverse electric field that is generated by pixel electrodes, to which active elements such as TFTs are connected, and a common electrode that is shared by the pixels.

Known liquid crystal display devices of IPS mode that have been disclosed include, for instance, an active matrix-type liquid crystal display device relying on a transverse electric field mode, wherein the angle formed by a side face of at least one from among the pixel electrode and the common electrode with respect to the substrate surface is greater than 0° but smaller than 90°, as a technique for increasing contrast and preventing the occurrence of uneven brightness (for instance, Patent document 1).

The TBA mode is a display mode in which a p-type nematic liquid crystal is used as the liquid crystal material, and the liquid crystal is driven by a transverse electric field, to define thereby the alignment orientation of the liquid crystal molecules. The TBA mode allows maintaining high contrast properties through vertical alignment.

Patent document 1: Japanese Patent Application Laid-open No. H9-90410

An explanation follows next on the problem of the present invention, and the way in which the present invention was arrived at, based on an example of a liquid crystal display device of the above-described transverse electric field mode. However, the liquid crystal display device according to the present invention is not limited to a liquid crystal display device of the above-described transverse electric field mode.

In conventional liquid crystal display devices of transverse electric field mode, there were instances where noise occurred in a common signal that is applied to a common electrode, and display quality decreased as a result. Specifically, screen flicker and dark portions (shadows) were known to occur.

These phenomena are significant, in particular, in high definition pixels. Ordinarily, moreover, higher pixel definitions entail thinner wiring widths and greater pixel counts. Therefore, the above phenomena are deemed to occur on account of additional capacitance, i.e. supplementary capacitance, that gives rise to noise in a common signal.

### DISCLOSURE OF THE INVENTION

In the light of the above, it is an object of the present invention to provide a liquid crystal display device that allows suppressing loss of display quality caused by additional capacitance.

As a result of diligent research on liquid crystal display devices that allow suppressing loss of display quality caused by additional capacitance, the inventors came to focus on the input (application) of common signals to a common electrode. The inventors found that, in the technology disclosed in Patent document 1, for instance, the common electrode and gate bus lines or source bus lines are disposed at a same layer, in a display area. Accordingly, the gate bus line and the source bus line become obstacles and thus the common signal can be inputted to the common electrode only from the top and bottom, or from the left a right, of the display area, so that, as a result, additional capacitance increases as described above.

As a result of further research, the inventors found that the layout of the common electrode can be designed with a greater degree of freedom, without affecting the layout of gate bus lines or source bus lines, by arranging the common electrode at a layer that is different from the layer at which the gate bus lines are formed and the layer at which the source bus lines are formed. This allows inputting a common signal to the display area from more directions than in conventional cases, so that additional capacitance can be suppressed as a result. The inventors found that the above problems could be admirably solved thereby, and arrived thus at the present invention.

The present invention provides a liquid crystal display device provided with: a first substrate and a second substrate disposed opposing each other; and a liquid crystal layer sandwiched between the first substrate and the second substrate, wherein the first substrate has a gate bus line, a source bus line, a pixel electrode to which an image signal is inputted, and a common electrode to which a common signal is inputted, the pixel electrode and the common electrode are comb-shaped within a pixel, an electric field parallel to the surface of the first substrate is generated between the pixel electrode and the common electrode within the pixel, and the common electrode is arranged, within a display area, at a layer that is different from a layer at which the gate bus line is formed and from a layer at which the source bus line is formed.

Herein, the feature “electric field parallel to the surface of the first substrate is generated” denotes “electric field is generated having at least a component that is parallel to surface of the first substrate”. That is, the language “parallel” encompasses “substantially parallel” and “oblique”.

The configuration of the liquid crystal display device of the present invention is not especially limited as long as it essentially includes such components.

Preferable embodiments of the liquid crystal display device of the present invention are mentioned in more detail below. The following embodiments may be employed in combination.

Preferably, the common signal is inputted to the display area from at least three directions, along the gate bus line and the source bus line (more preferably, along the extension direction of the gate bus line and the source bus line in the display area). Additional capacitance can be suppressed more reliably thereby.

Preferably, the common signal is inputted to the display area from four directions, along the gate bus line and the source bus line (more preferably, along the extension direction of the gate bus line and the source bus line in the display area). Additional capacitance can be further suppressed thereby, which allows further suppressing drops in display quality.

In more concrete terms, preferably, the display area has a rectangular shape in a plan view, and the common signal is inputted to the display area from at least three sides of the display area. As a result, this allows reliably inputting a common signal into a display area having a rectangular shape in a plan view, from at least three directions.

In this case, preferably, the common signal is inputted to the display area from four sides of the display area. As a result, this allows reliably inputting a common signal into a display area having a rectangular shape in a plan view, from four directions.

Preferably, the common electrode intersects the gate bus line and the source bus line outside the display area. As a result, the common electrode can be disposed so as to surround the outer periphery of the display area. Therefore, this allows inputting effectively a common signal into the display area from at least three directions.

Preferably, the common electrode surrounds an entire outer periphery of the display area. This allows inputting effectively a common signal into the display area from four directions.

Preferably, the common electrode includes a boundary portion (common boundary portion) formed along a boundary between adjacent pixels, and a branch portion (common branch portion) extending from the boundary portion into the pixel.

Preferably, the boundary portion covers the gate bus line and the source bus line. As a result, this allows shielding against the electric fields that are generated by the gate bus line and the source bus line. Accordingly, it becomes possible to suppress the occurrence of alignment defects of the liquid crystal molecules caused by such electric fields, i.e. the occurrence of domain defect in the pixels.

Preferably, the common electrode and the pixel electrode are disposed at a same layer within the display area. This allows simplifying the manufacturing process.

Preferably, the first substrate further has a storage capacitance wiring, and the storage capacitance wiring is disposed, within the display area, at a layer different from a layer at which the common electrode is formed. As a result, storage capacitance wiring can be formed without affecting the layout of the common electrode.

Preferably, a signal that is identical to the common signal is inputted to the storage capacitance wiring. Costs can be reduced as a result.

Preferably, the storage capacitance wiring is connected to the common electrode. As a result, a signal identical to the common signal can be effectively inputted to the storage capacitance wiring.

Preferably, the storage capacitance wiring is connected to the common electrode outside the display area. As a result, no contact holes for connecting the storage capacitance wiring and the common electrode need be formed within the display area (pixel). This allows enhancing both the pixel aperture ratio and transmittance.

Preferably, the first substrate further has a Cs connection wiring formed outside the display area, and the Cs connection wiring connects one end to another end of the storage capacitance wiring. This allows inputting a signal from both ends of the storage capacitance wiring.

Preferably, the Cs connection wiring is connected to the common electrode outside the display area. As a result, the storage capacitance wiring and the common electrode can be connected by way of a Cs connection wiring outside the display area (pixel), without the need for forming a contact hole for connecting the storage capacitance wiring and the common electrode, within the display area (pixel).

Preferably, the common electrode is disposed, within the display area, further on the side of the liquid crystal layer than the gate bus line and the source bus line. This allows generating, more effectively, an electric field that is parallel to a liquid crystal layer.

In this case, preferably, the first substrate further has an interlayer dielectric provided between the layers of the common electrode and of the gate bus line or the source bus line, and the interlayer dielectric includes an insulating resin film. As a result, it becomes possible to use a film having low relative permittivity as the insulating resin film. In turn, this allows suppressing the occurrence of signal delay.

Preferably, the insulating resin film contains an acrylic resin. This allows reducing effectively the relative permittivity of the insulating resin film.

Preferably, the insulating resin film is photosensitive. This allows simplifying the process of forming a contact hole for connecting a common electrode and a lower-layer wiring layer.

Preferably, the relative permittivity of the insulating resin film ranges from 2.7 to 4.5 (more preferably, from 3.4 to 3.8).

More specifically, preferably, the liquid crystal layer includes a p-type nematic liquid crystal.

The p-type nematic liquid crystal may be vertically aligned with respect to the surfaces of the first substrate and of the second substrate when no voltage is applied, or may be horizontally aligned with respect to the surfaces of the first substrate and of the second substrate when no voltage is applied. In the former case, there can be realized a TBA-mode liquid crystal display device that elicits the effect of the present invention, while in the latter case there can be realized an IPS-mode liquid crystal display device that elicits the effect of the present invention.

The feature “the p-type nematic liquid crystal may be vertically or horizontally aligned with respect to the surfaces of the first substrate and of the second substrate when no voltage is applied” means that “the p-type nematic liquid crystal has at least an alignment component that is vertical or horizontal with respect to the surfaces of the first substrate and the second substrate”. That is, the language “vertical” encompasses “substantially vertical” and “horizontal” encompasses “substantially horizontal”.

### EFFECT OF THE INVENTION

A liquid crystal display device of the present invention allows suppressing loss of display quality caused by additional capacitance.

### BRIEF DESCRIPTION OF THE DRAWINGS

FIG. 1 is a plan-view schematic diagram illustrating the configuration of a liquid crystal display device of Embodiment 1;

FIG. 2(a) is a plan-view schematic diagram illustrating the configuration of a subpixel in the liquid crystal display device of Embodiment 1, and FIG. 2(b) is a conceptual diagram illustrating an arrangement relationship of the transmission axes in polarizers of the liquid crystal display device of Embodiment 1;

FIG. 3 is a cross-sectional schematic diagram illustrating the configuration of a liquid crystal display device of Embodiment 1, depicting a cross section along line X-Y of FIG. 2(a);

FIG. 4 is a cross-sectional schematic diagram illustrating the configuration of the liquid crystal display device of Embodiment 1, depicting an alignment distribution of the liquid crystal during voltage application; and

FIG. 5 is a cross-sectional schematic diagram illustrating the configuration of the liquid crystal display device of Embodiment 2.

### MODE FOR CARRYING OUT THE INVENTION

The present invention will be mentioned in more detail referring to the drawings in the following embodiments, but is not limited to these embodiments.

In the embodiments below, the 3 o'clock direction, the 12 o'clock direction, the 9 o'clock direction and the 6 o'clock direction denote respectively a 0° direction (orientation), a 90° direction (orientation), a 180° direction (orientation) and a 270° direction (orientation); while the direction running through 3 o'clock and 9 o'clock is a left-right direction and the direction running through 12 o'clock to 6 o'clock is a top-down direction, in a front view of the liquid crystal display device, i.e. in a plan view of surfaces of the active matrix substrate and the opposed substrate.

The plan view denotes a plan view of the display surface of the liquid crystal display device, i.e. of the substrate main surface.

A plan-view shape denotes herein a shape that is viewed in a plan view.

### EMBODIMENT 1

The liquid crystal display device of the present embodiment is a transmissive liquid crystal display device that relies on a so-called TBA mode, from among liquid crystal display devices of transverse electric field mode in which an electric field (transverse electric field) acts on a liquid crystal layer in a substrate surface direction (direction parallel to the substrate surface), and the alignment of the liquid crystal is controlled, to perform thereby image display.

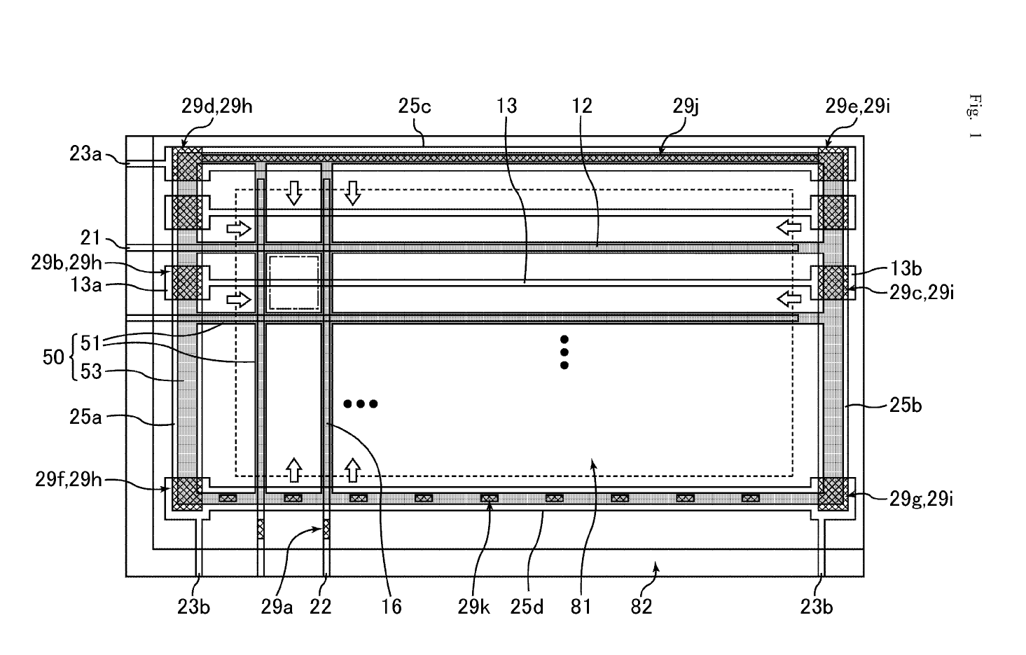

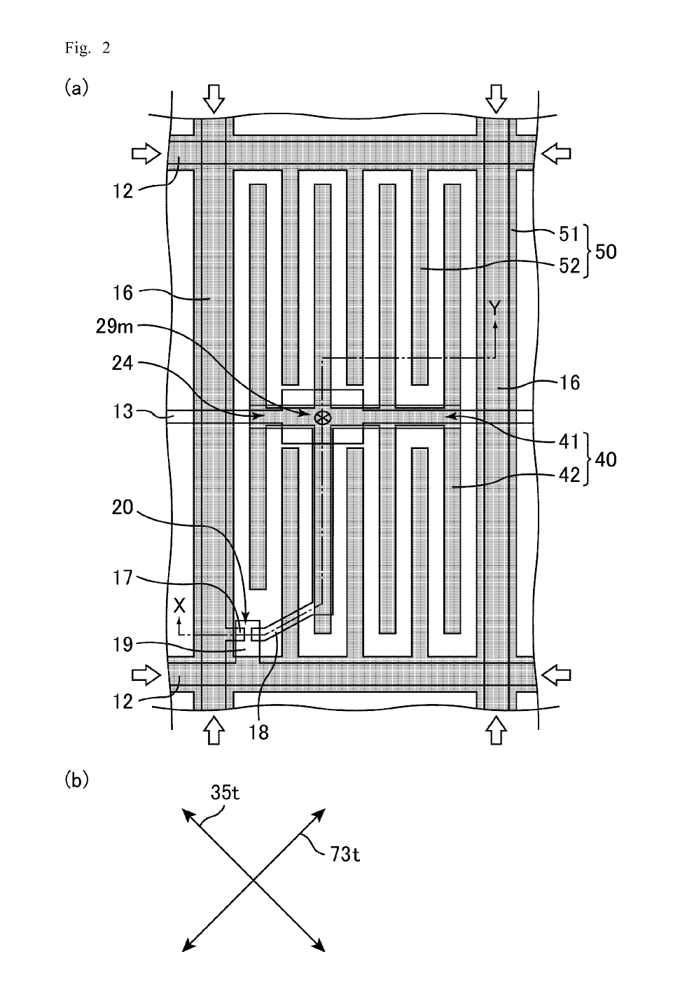

As shown in FIG. 1 and FIG. 2, the liquid crystal display device of the present embodiment has a display area (image display region) 81, having a rectangular shape in a plan view, in which images are displayed, and a quadrangular frame-like rim area 82 in which no images are displayed. On the display area 81 there is formed a matrix-like plurality of pixels comprising each a plurality of subpixels. The rim area 82 is a region outside the display area 81, such that the rim area 82 surrounds the entire outer edge of the display area 81.

The region enclosed by the broken line in FIG. 1 corresponds to the display area 81, and the region surrounded by the dashed line corresponds to one subpixel. For simplicity, only one subpixel is depicted in FIG. 1, but actually the subpixels are arrayed in the form of a matrix, up, down, left and right. The hatched areas in FIG. 1 denote contact holes. The gray areas in FIG. 1 and FIG. 2 denote a third conductive layer.

On each subpixel there is formed a pixel electrode 40 and a thin film transistor (TFT) 20 for switching control of the pixel electrode 40.

A source 17 of each TFT 20 is electrically connected to a plurality of source bus lines 16 that is connected to a source driver (data line driving circuit). The source driver supplies image signals to respective subpixels via the source bus lines 16.

A gate 19 of each TFT 20 is electrically connected to the plurality of gate bus lines 12 that is connected to a gate driver (scanning line driving circuit). Scan signals supplied in pulses by the gate driver to the gate bus lines 12 at predetermined timings are applied line-sequentially, in this order, to each TFT 20.

The pixel electrode 40 is electrically connected to the drain 18 of the TFT 20. An image signal supplied by the source bus lines 16 is applied, at a predetermined timing, to the pixel electrode 40 that is connected to the TFT 20 that has been brought to an on state for a given period of time through the input of a scan signal. Image signals are written thereby into a liquid crystal layer 60.

An image signal of a predetermined level written to the liquid crystal layer 60 is held for a given time interval between the pixel electrode 40 to which an image signal is applied, and a common electrode 50 that opposes the pixel electrode 40 in the subpixel. That is, a capacitance (liquid crystal capacitance) is formed, for a given time interval, between the electrodes 40 and 50. Storage capacitance is formed in parallel to the liquid crystal capacitance, in order to prevent leaks in the image signal that is held. In each subpixel, the storage capacitance is formed between the drain 18 of the TFT 20 and a Cs bus line (capacitance hold wiring) 13.

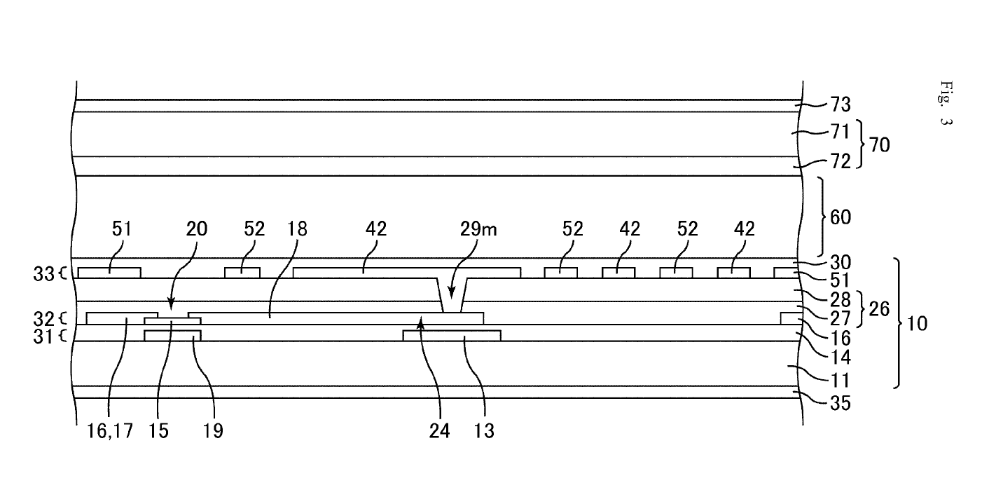

The configuration of the liquid crystal display device of the present embodiment is explained in more detail next. The liquid crystal display device of the present embodiment comprises a liquid crystal display panel and a backlight unit (not shown) provided on the rear face side of the liquid crystal display panel. As illustrated in FIG. 3, the liquid crystal display panel comprises an active matrix substrate (TFT array substrate) 10, an opposed substrate 70 opposing the active matrix substrate 10, and the liquid crystal layer 60 sandwiched therebetween.

The active matrix substrate 10 has, on one main surface(on the liquid crystal layer 60 side) of a colorless transparent insulating substrate 11, a plurality of gate bus lines 12 through which scan signals are transmitted; a plurality of Cs bus lines 13; a plurality of source bus lines 16 through which an image signal is transmitted; a plurality of TFTs 20, as switching elements, such that one TFT 20 is provided at each subpixel; a plurality of drains 18, such that one drain 18 is connected to each TFT 20; a plurality of pixel electrodes 40 provided each in a respective subpixel; a common electrode 50 shared by the subpixels; and a vertical alignment film 30 provided on the surface, on the liquid crystal layer 60 side, that covers the foregoing build-up.

In terms of cross-sectional structure, the active matrix substrate 10 has a structure in which a plurality of wirings and a plurality of insulating layers are alternately stacked. More specifically, the active matrix substrate 10 has, on the side of the inward main surface of the insulating substrate 11 (liquid crystal layer 60 side), a structure in which there are sequentially stacked, from the insulating substrate 11 side, a first layer (first conductive layer 31) in which a conductive member, such as the gate bus lines 12, is formed; a gate insulator 14; a semiconductor layer 15; a second layer (second conductive layer 32) in which a conductive member, such as the source bus lines 16, is formed; an interlayer dielectric 26 having a insulating resin film (organic insulating film) 28 stacked on a top layer (liquid crystal layer 60) side of a inorganic insulating film 27; a third layer (third conductive layer 33) in which a conductive member such as the common electrode 50 is formed; and a vertical alignment film 30.

The respective members of the first conductive layer 31 and the second conductive layer 32 are formed of a metal film, for instance aluminum. The respective members of the third conductive layer 33 are formed of a transparent conductive film of ITO or the like, or a metal film such as aluminum, chromium or the like.

The insulating substrate 11 is a substrate (base substrate) comprising a light-transmitting material such as glass, quartz, plastic or the like.

The gate bus lines 12 are disposed parallel to each other in the left-right direction. The source bus lines 16 are disposed parallel to each other in the top-down direction. The Cs bus lines 13 are disposed parallel to each other in the left-right direction. Thus, the gate bus lines 12 and the Cs bus lines 13 are disposed alternately with each other and parallel to each other.

In the present embodiment, the subpixel region is broadly defined as the region surrounded by the gate bus lines 12 and the source bus lines 16. The Cs bus lines 13 are disposed so as to run along the vicinity of the center of each subpixel region.

One end of each gate bus line 12 leads out (extends) up to the rim area 82, such that a respective gate terminal 21 is connected to the tip of the one end of the gate bus line 12. A terminal of the gate driver is connected to the gate terminal 21. The gate bus lines 12 and the gate terminals 21 are formed contiguously (integrally) with each other in the first conductive layer 31.

One end of each source bus line 16 leads out (extends) outward of the display area 81, i.e. up to the rim area 82, such that a respective source terminal 22 is connected to the tip of the end of each source bus line 16. A terminal of the source driver is connected to the source terminal 22.

The source bus lines 16 are formed in the second conductive layer 32, and the source terminals 22 are formed in the first conductive layer 31. The source bus lines 16 and the source terminal 22 are connected by way of a contact hole 29a provided in the gate insulator 14.

Both ends (end portions 13a, 13b) of each Cs bus lines 13 lead out (extend) up to regions to the left and right of the rim area 82, in such a manner that the width at both ends is greater. The end portions 13a are connected to each other, and likewise, the end portions 13b are connected to each other.

More specifically, a Cs connection wiring (Cs trunk) 25a is provided, in the top-down direction, at a region overlapping the end portions 13a, and a Cs connection wiring 25b is provided, in the top-down direction, at a region overlapping the end portions 13b. The Cs bus lines 13 are formed in the first conductive layer 31, while the Cs connection wirings 25a, 25b are formed in the second conductive layer 32 that is different from the first conductive layer 31.

The Cs connection wiring 25a and the end portions 13a are connected by way of contact holes 29b that are provided in the gate insulator 14. The Cs connection wiring 25b and the end portions 13b are connected by way of contact holes 29c that are provided in the gate insulator 14.

The Cs connection wiring 25a and the Cs connection wiring 25b are connected to each other. More specifically, a Cs connection wiring 25c is provided, in the left-right direction, upward of the rim area 82 where there are no Cs connection wirings 25a, 25b. A Cs connection wiring 25d is provided, in the left-right direction, downward of the rim area 82 where there are no Cs connection wirings 25a, 25b. The Cs connection wirings 25c, 25d are formed in the first conductive layer 31, like the Cs bus lines 13 and the gate bus lines 12.

The Cs connection wiring 25c is connected to the upper end of the Cs connection wiring 25a, via a contact hole 29d provided in the gate insulator 14, and is connected to the upper end of the Cs connection wiring 25b via a contact hole 29e provided in the gate insulator 14. The Cs connection wiring 25d is connected to the lower end of the Cs connection wiring 25a via a contact hole 29f provided in the gate insulator 14, and is connected to the lower end of the Cs connection wiring 25b via a contact hole 29g provided in the gate insulator 14.

As a result, both ends (end portions 13a, 13b) of the Cs bus lines 13 become connected to each other, and hence a signal (common signal) can be supplied from both ends (end portions 13a, 13b) of the Cs bus lines 13 into the display area.

A Cs terminal 23a is connected to one tip of the Cs connection wiring 25c, and Cs terminals 23b are connected to both ends of the Cs connection wiring 25d. Signal (common signal) terminals are connected to the Cs terminals 23a, 23b.

A detailed explanation follows next on the configuration of the present embodiment, focusing mainly on one subpixel.

The pixel electrode 40 has a comb-like plan-view shape. More specifically, the pixel electrode 40 has a pixel trunk portion 41 and a pixel branch portion 42.

The pixel trunk portion 41 is a portion (trunk portion) shaped as a band (rectangular shape in a plan view) and disposed so as to planarly overlap the Cs bus lines 13.

The pixel branch portion 42 is a portion (branch portion, comb tooth) connected to the trunk portion 21, the pixel branch portion 42 being provided in the 90° or 270° direction and having a linear shape in a plan view.

The pixel trunk portion 41 and the pixel branch portion 42 are formed in the third conductive layer 33 and are connected to each other by being formed contiguously (integrally) with each other.

The common electrode 50 has also a comb shape, in a plan view, within each subpixel. More specifically, the common electrode 50 has a common boundary portion 51, a common branch portion 52 and a common frame portion 53.

The common frame portion 53 is a frame-like portion provided outside the display area 81. The common frame portion 53 is connected to the Cs connection wiring 25a by way of a contact hole 29h provided in the interlayer dielectric 26, and is connected to the Cs connection wiring 25b by way of a contact hole 29i provided in the interlayer dielectric 26. Further, the common frame portion 53 is connected to the Cs connection wiring 25c by way of a contact hole 29j that runs through the gate insulator 14 and the interlayer dielectric 26, and is connected to the Cs connection wiring 25d by way of a contact hole 29k that runs through the gate insulator 14 and the interlayer dielectric 26.

That is, the common frame portion 53 (common electrode 50) is connected to the Cs bus lines 13 by way of the Cs connection wirings 25a, 25b, 25c, 25d. As a result, an identical signal, i.e. common signal, can be supplied (inputted) to the Cs bus lines 13 and the common electrode 50. Costs can be reduced as a result.

The common frame portion 53 (common electrode 50) is connected to the Cs bus lines 13 outside the display area 81. That is, the contact holes (contact hole 29b, 29d, 29f, 29h, 29j, 29k and so forth) for connecting the Cs bus lines 13 and the common electrode 50 are all formed outside the display area 81. Therefore, the contact hole for connecting the Cs bus lines 13 and the common electrode 50 need not be formed within the display area 81 (within the pixel). This allows enhancing both the subpixel aperture ratio and transmittance. Also, the contact holes need not be formed within the subpixels. This allows minimizing the surface area of the Cs bus lines 13, increasing the subpixel aperture ratio, and enhancing transmittance. The contact holes are all formed outside the display area 81. Therefore, the number and surface area of the contact holes can be increased easily, which allows reducing contact resistance and preventing signal delay.

The common boundary portion (boundary portion) 51 is a portion formed along the boundary between adjacent subpixels. That is, the common boundary portion 51 is formed along the gate bus lines 12 and the source bus lines 16. The common boundary portion 51 is formed in the form of grid in such a way so as to planarly overlap the gate bus lines 12 and the source bus lines 16.

The common boundary portion 51 is connected to the common frame portion 53 outside the display area 81. As a result, the common signal supplied by the Cs terminals 23a, 23b is supplied into the display area 81 by way of the Cs bus lines 13, the Cs connection wirings 25a, 25b, 25c, 25d and the common frame portion 53.

Specifically, the common signal is inputted to the common boundary portion 51 from four directions, up, down left and right. The common boundary portion 51 is formed along the gate bus lines 12 and the source bus lines 16, and hence the common signal is inputted in four directions, up, down, left and right, along the gate bus lines 12 and the source bus lines 16 (extension direction of the gate bus lines 12 and the source bus lines 16 in the display area 81).

Likewise, the common signal is inputted to the display area from the four sides of the display area having a rectangular shape in a plan view.

The common boundary portion 51 covers the gate bus lines 12 and the source bus lines 16, within the display area 81, so as to shield against the electric field generated by the gate bus lines 12 and the source bus lines 16. This allows suppressing the occurrence of alignment defects of the liquid crystal molecules caused by such electric fields, i.e. suppressing the occurrence of domain defects in the subpixels.

The common boundary portion 51 overlaps the gate bus lines 12 and the source bus lines 16. This allows enhancing both the subpixel aperture ratio and transmittance.

The common branch portion (branch portion, comb tooth) 52 is connected to the common boundary portion 51 and has a linear shape in a plan view, extending from the common boundary portion 51 towards the center of the subpixel. More specifically, the common branch portion 52 is formed in a 90° or 270° direction from a portion overlapping the gate bus lines 12 of the common boundary portion 51.

The common frame portion 53, the common boundary portion 51 and the common branch portion 52 are formed in the third conductive layer 33, and are connected to each other by being formed contiguously (integrally) with each other.

Thus, the pixel branch portion 42 and the common branch portion 52 have mutually complementary plan-view shapes, and are disposed alternately with a given spacing therebetween. Specifically, the pixel branch portion 42 and the common branch portion 52 are disposed to be parallel to and facing each other, within a same plane. In other words, the comb-shaped pixel electrode 40 and the comb-shaped common electrode 50 are oppositely disposed in such a manner that the comb teeth mesh with each other. The pixel electrode 40 and the common electrode 50 are disposed on a same layer (third conductive layer 33) on the interlayer dielectric 26 (insulating resin film 28). That is, the pixel electrode 40 and the common electrode 50 are disposed further towards the liquid crystal layer 60 side than the gate bus lines 12 and the source bus lines 16. As a result, this allows forming a higher-density transverse electric field across the pixel electrode 40 and the common electrode 50, allows the liquid crystal layer 60 to be controlled with higher precision, and affords higher transmittance. Also, the pixel electrode 40 and the common electrode 50 can be formed in one same process, which allows simplifying the manufacturing process.

In each subpixel, the pixel electrode 40 and the common electrode 50 have a substantially symmetrical plan-view shape with respect to the centerline that traverses the center of the subpixel in the left-right direction.

The width of the pixel branch portion 42 (length in the transverse direction) and the width of the common branch portion 52 (length in the transverse direction) are substantially the same at regions where the pixel branch portion 42 and the common branch portion 52 oppose each other.

From the viewpoint of enhancing transmittance, the width of the pixel branch portion 42 and of the common branch portion 52 is preferably as small as possible. In current process tools, these widths are preferably set to about 1 to 4 μm (more preferably, about 2.5 to 4.0 μm).

The electrode spacing (width of the gap between the pixel branch portion 42 and the common branch portion 52) S is not particularly limited, but ranges preferably from 2.5 to 20.0 μm (more preferably, from 4.0 to 12.0 μm). Transmittance may drop if the spacing S exceeds 20.0 μm or is smaller than 2.5 μm.

The TFTs 20 are disposed in the vicinity of the intersection between the gate bus lines 12 and the source bus lines 16, such that each TFT 20 comprises a gate (gate electrode) 19, a semiconductor layer 15, a source (source electrode) 17 and a drain (drain electrode) 18.

The gate 19 is formed in the first conductive layer 31, and is connected to a respective gate bus line 12 by being formed contiguously (integrally) with the latter.

The gate insulator 14 is formed of a transparent insulating material, for instance silicon oxide, in such a way so as cover the first conductive layer 31, of the gate bus lines 12 and so forth.

The semiconductor layer 15 is formed, as an island, on the gate 19, via the gate insulator 14. The semiconductor layer 15 is formed out of an amorphous silicon film.

One end portion of the source 17 and one end portion of the drain 18 overlap (overlie) each other planarly on the semiconductor layer 15. The source 17 is formed in the second conductive layer 32, and is connected to a respective source bus line 16 by being formed contiguously (integrally) with the latter. That is, the source 17 is a wiring that branches from a source bus line 16 and extends into the semiconductor layer 15, to connect the source bus line 16 and the TFT 20.

The drain 18 is a wiring having substantially an L-shape in a plan view and that extends from the semiconductor layer 15. Like the source 17, the drain 18 is formed in the second conductive layer 32.

Thus, the TFT 20 is a channel-etch type TFT produced according to a manufacturing method such that the semiconductor layer 15 is also etched to some extent during separation of the drain 18 and the source 17. The TFT 20 is also an inverted staggered type in which the gate 19 is provided further downwards (on the insulating substrate 11 side) than the drain 18 and the source 17.

The gate bus lines 12 and the Cs bus lines 13 may be formed further on the liquid crystal layer 60 side than the source bus lines 16. For instance, a stack may include the semiconductor layer 15, the gate insulator 14, the gate bus lines 12 and the Cs bus lines 13, an interlayer dielectric comprising a transparent insulating material such as an inorganic insulating film, the source bus lines 16, the interlayer dielectric 26, the pixel electrode 40 and the common electrode 50, in this order from the insulating substrate 11 side. In this case, the TFT 20 may be formed as a staggered- or planar-type TFT in which the gate 19 is provided further on the liquid crystal layer 60 side than the drain 18 and the source 17.

The drain 18 is connected to the pixel electrode 40, and forms storage capacitance. More specifically, the drain 18 has a band-like (rectangular shape in a plan view) storage capacitance portion 24 at the end portion on the side opposite to the TFT 20 (at the tip of the L-shape). The storage capacitance portion 24 is formed planarly overlapping the Cs bus line 13. Storage capacitance, having the storage capacitance portion 24 and the Cs bus line 13 as electrodes, is formed thus at the region where the storage capacitance portion 24 and the Cs bus line 13 overlap planarly each other. The storage capacitance portion 24 is disposed overlapping planarly the pixel trunk portion 41, and is connected to the pixel trunk portion 41 by way of a contact hole 29m that is provided in the interlayer dielectric 26. That is, the pixel electrode 40 is connected to the drain 18 by way of the contact hole 29m that is provided in the interlayer dielectric 26.

The interlayer dielectric 26 is provided so as to cover the semiconductor layer 15 and various members of the second conductive layer 32, i.e. the source 17, the source bus lines 16, the drain 18 and so forth.

The inorganic insulating film 27 is formed of a transparent insulating material, for instance silicon oxide formed by CVD. The insulating resin film 28 is formed of a transparent insulating material such as a photosensitive acrylic resin or the like.

An explanation follows next on the method for forming the interlayer dielectric 26. Firstly, the inorganic insulating film 27 is formed to a thickness of about 1500 to 4000 Å, and is then etched away at a region that constitutes the contact holes. Next, a photosensitive acrylic resin film is formed by spin-coating on the inorganic insulating film 27. Next, the resin film is exposed according to a desired pattern, and is developed using an alkaline solution. As a result, only the exposed portions are etched by the alkaline solution, such that contact holes are formed that run through the inorganic insulating film 27 and the insulating resin film 28. Specific examples of the photosensitive acrylic resin include, for instance, JAS-150 (relative permittivity=3.4) manufactured by JSR Corporation.

The relative permittivity of ordinary acrylic resins ranges from 2.7 to 4.5 (preferably from 3.4 to 3.8), which is lower than the relative permittivity of the inorganic insulating film (for instance, a relative permittivity of 8 for silicon nitride). Acrylic resins have high transparency and can be easily coated to a thickness of several μm by spin coating. In the present embodiment, therefore, the capacitance component of the members of the higher-layer third conductive layer 33 and the members of the lower-layer first conductive layer 31 and second conductive layer 32 can be reduced effectively. This allows, as a result, suppressing delay of image signals and so forth. Also, the common boundary portion 51 can overlap the gate bus lines 12 and the source bus lines 16, as described above, and the aperture ratio of the subpixel can be enhanced, while suppressing increases in the capacitive component.

Using a photosensitive resin film is advantageous in terms of productivity, since in this case no photoresist process of patterning a resin film is required.

The film thickness of the insulating resin film 28 is not particularly limited, but is preferably set so as to range from about 2 to 5 μm (more preferably, from about 3.5 to 4.5 μm). The capacitive component may increase when the thickness is smaller than 2 μm, while transmittance may drop when the thickness exceeds 5 μm.

The vertical alignment film 30, of polyimide or the like, is formed so as to cover the pixel electrode 40 and the common electrode 50.

The opposed substrate 70 has: a black matrix (BM) layer (not shown) that performs light shielding in the rim area 82 and between adjacent subpixels, on one of the main surfaces (on the liquid crystal layer 60 side) of the colorless transparent insulating substrate 71; a plurality of colored layers (color filters, not shown) provided for each respective subpixel; and a vertical alignment film 72 provided on the surface, on the liquid crystal layer 60 side, that covers the foregoing build-up.

The insulating substrate 71 is a substrate (base substrate) comprising a light-transmitting material such as glass, quartz, plastic or the like.

The BM layer is formed, for instance, out of a non-transparent metal such as Cr, or out of a non-transparent organic film, for instance an acrylic resin containing carbon. The BM layer is formed, within the display area 81, at a region surrounding the subpixel region, i.e. a region corresponding to the gate bus lines 12 and the source bus lines 16.

The colored layers are used for performing color display. The colored layers are formed out of a transparent organic film or the like, for instance of acrylic resin containing a pigment. Each colored layer is formed mainly at the subpixel region.

The vertical alignment films 30, 72 are formed by coating of a known alignment film material such as polyimide. Ordinarily, the vertical alignment films 30, 72 are not subjected to a rubbing process, such that the vertical alignment films 30, 72 can align the liquid crystal molecules substantially vertically with respect to the film surface, when no voltage is applied.

The liquid crystal display device of the present embodiment is a color liquid crystal display device provided with a colored layer on an opposed substrate 70 (active matrix-type liquid crystal display device for color display), such that each pixel is made up of three subpixels that output light of a respective color, namely R (red), G (green) and blue (B).

The color and number of subpixels that make up each pixel is not particularly limited, and can be set as the case may require. In the liquid crystal display device of the present embodiment, for instance, each pixel may be made up of three subpixels, cyan, magenta and yellow, but may be made up of subpixels of four or more colors. The liquid crystal display device of the present embodiment may be a black-and-white display.

Preferably, a planarizing film (undercoat film) formed of a transparent resin material or the like is further stacked on the liquid crystal layer 60 side of the BM layer and of the colored layers, in order to planarize level differences that arise in the above configuration. As a result, this allows uniformizing the thickness of the liquid crystal layer 60 by making the surface of the opposed substrate 70 flatter, and allows preventing drops in contrast caused by driving voltage unevenness within a subpixel region.

The active matrix substrate 10 and the opposed substrate 70 are bonded by a sealing agent that is provided so as to surround the display area 81, via a spacer such as plastic beads or the like. A liquid crystal layer 60 is formed, by sealing a liquid crystal material, as a display medium that makes up an optical modulation layer, in the gap between the active matrix substrate 10 and the opposed substrate 70.

The liquid crystal layer 60 comprises a nematic liquid crystal material (p-type nematic liquid crystal material) having positive dielectric anisotropy. When no voltage is applied (i.e. when no electric field is generated by the pixel electrode 40 and the common electrode 50), the liquid crystal molecules of the p-type nematic liquid crystal material exhibit an homeotropic alignment on account of the alignment restricting force of the vertical alignment films 30, 72 of the opposed substrate 70 and the active matrix substrate 10. When no voltage is applied, more specifically, the major axis of the liquid crystal molecules of the p-type nematic liquid crystal material in the vicinity of the vertical alignment films 30, 72 forms an angle of 88° or greater (more preferably 89° or greater) with respect to the surfaces of the active matrix substrate 10 and the opposed substrate 70.

A polarizer 35 is bonded to the outer main surface side (side opposite that of the liquid crystal layer 60) of the active matrix substrate 10, and a polarizer 73 is bonded to the outer main surface side of the opposed substrate 70. The liquid crystal display device of the present embodiment may have a retarder and/or a viewing angle compensation film.

The arrangement of each optical axis in the liquid crystal display device of the present embodiment is as illustrated in FIG. 2(b). A transmission axis 31t of the polarizer 31 on the active matrix substrate 10 side, and transmission axis 73t of the polarizer 73 on the opposed substrate 70 side are disposed so as to form an angle of 45°, in a plan view, with respect to the pixel branch portion 42 and the common branch portion 52. The transmission axis 35t and the transmission axis 73t point in a 45° oblique direction, and are arranged in a cross nicol configuration.

In the liquid crystal display device of the present embodiment having the above features, application of an image signal (voltage) to the pixel electrode 40 via the TFT 20 causes an electric field (transverse electric field) to be generated between the pixel electrode 40 and the common electrode 50 in the surface direction of the substrates 10 and 70, i.e. there is generated an electrical field that is parallel to the surfaces of the substrates 10 and 70. The liquid crystal is driven by the transverse electric field, and the transmittance of each subpixel changes, to perform image display thereby.

In the liquid crystal display device of the present embodiment, more specifically, application of an electric field results in the formation of a distribution of electric field intensity within the liquid crystal layer 60. This distorts the alignment of the liquid crystal molecules, so that the retardation of the liquid crystal layer 60 is changed thereby. More specifically, the initial alignment state of the liquid crystal layer 60 is a homeotropic alignment. A bend-like electric field is formed through generation of a transverse electric field in the liquid crystal layer 60 upon application of voltage to the comb-shaped pixel electrode 40 and the common electrode 50. As a result, two domains dissimilar by 180° form in alternate director directions, as illustrated in FIG. 4. In each domain (between each electrode) the liquid crystal molecules of the nematic liquid crystal material exhibit a bend-like liquid crystal array (bend alignment).

In the present embodiment, the common electrode 50 is arranged, within the display area 81, at a layer (third conductive layer 33) that is different from the layers (first conductive layer 31 and second conductive layer 32) at which the gate bus lines 12 and the source bus lines 16 are formed. As described above, this allows setting more freely the layout of the common electrode 50, without affecting the layout of the gate bus lines 12 and the source bus lines 16. As a result, a common signal can be inputted to the display area 81 from more directions (at least three directions) than in a conventional case, specifically the common signal can be inputted from the directions denoted by the blank arrows in FIG. 1. In conventional technologies, a common signal could be inputted to the display area only from at most two sides of the display area. In the present embodiment, the common signal can be inputted to three or more (preferably, four sides) of the display area. In the subpixel as well, the common signal is inputted from more directions (at least three directions) than in a conventional case, specifically in the directions denoted by the blank arrows in FIG. 2(a). As a result, this allows suppressing generation of noise in the common signal, caused by additional capacitance. It becomes therefore possible to suppress screen flicker and the occurrence of relatively dark portions (shadows). This effect becomes more conspicuous at higher pixel definitions.

Outside the display area 81, i.e. in the rim area 82, the common electrode 50 has a portion at which the gate bus lines 12 and the source bus lines 16 intersect in a plan view. As a result, this allows forming the common frame portion 53 so as to surround the outer periphery of the display area 81, as described above, and allows inputting effectively a common signal into the display area 81 from at least three directions.

In the present embodiment, moreover, the common frame portion 53 surrounds the entire outer periphery of the display area 81. As a result, a common signal can be effectively inputted to the display area 81 from four directions (in the present embodiment, top, down, left and right directions).

The common frame portion 53 may be formed as a U-shape, in such a way so as enclose the display area 81 only from three sides. Thereby, the common signal can be inputted to the display area 81 from three directions (for instance, top, down and right directions; top, down and left directions; left, right and top directions; or left, right and down directions), which is still more directions than in a conventional case. Also, the rim region 82 can be reduced by omitting the Cs connection wiring 25c or the Cs connection wiring 25b.

The liquid crystal display device of the present embodiment has been explained based on an example of a TBA mode, but the liquid crystal display device of the present embodiment may be a liquid crystal display device of IPS mode. In this case, a horizontal alignment film may be formed instead of the vertical alignment films 30, 72, such that the horizontal alignment film is subjected to rubbing. Also, the material used as the p-type nematic liquid crystal material may be such that when no voltage is applied, the material is aligned substantially horizontally with respect to the surface of the active matrix substrate 10 and the opposed substrate 70. The same effect as in the case of a TBA mode can be elicited as a result.

The liquid crystal display device of the present embodiment may be of reflective type, or may be of semi-transmissive type (transmissive/reflective type).

### EMBODIMENT 2

The liquid crystal display device of the present embodiment differs from that of Embodiment 1 as regards the features below.

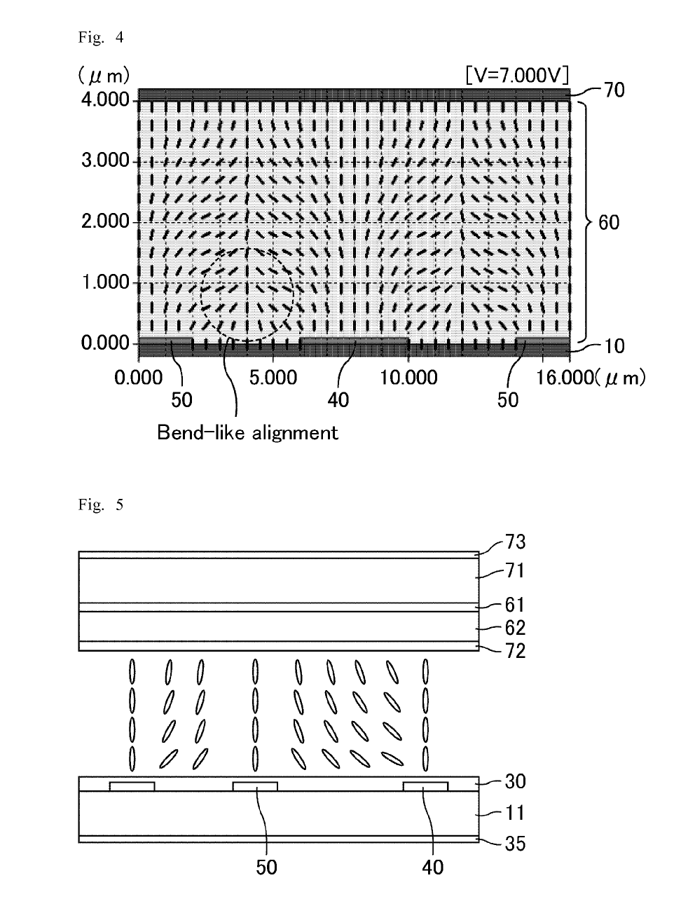

Herein, the liquid crystal display device of the present embodiment has a counter electrode on the opposed substrate side. Specifically, as illustrated in FIG. 5, the counter electrode 61, the dielectric layer (insulating layer) 62, and the vertical alignment film 72 are stacked, in this order, on the main surface, on the liquid crystal layer 60 side, of the insulating substrate 71. A plurality of colored layers (color filters) and/or a black matrix (BM) layer may be provided between the counter electrode 61 and the insulating substrate 71.

The counter electrode 61 is formed of a transparent conductive film of ITO, IZO or the like. The counter electrode 61 and the dielectric layer 62 are formed without breaks so as to cover at least the entire display area 81. A predetermined potential shared by the subpixels is applied to the counter electrode 61.

The dielectric layer 62 is formed of a transparent insulating material. Specifically, the dielectric layer 62 is formed of an inorganic insulating film such as silicon nitride, or of an organic insulating film such as an acrylic resin or the like.

As in Embodiment 1, a comb-shaped electrode comprising the pixel electrode 40 and the common electrode 50, and a vertical alignment film 30, are provided on the insulating substrate 11. Polarizers 35, 73 are disposed on the outer main surface of the two insulating substrates 11, 71.

Other than during black display, dissimilar voltages are applied between the pixel electrode 40, and the common electrode 50 and the counter electrode 61. The common electrode 50 and the counter electrode 61 may be grounded. The voltages applied to the common electrode 50 and the counter electrode 61 may be of the same magnitude and polarity, or of dissimilar magnitude and polarity.

As in the case of Embodiment 1, the liquid crystal display device of the present embodiment allows suppressing loss of display quality caused by additional capacitance. The response time can be enhanced by forming the counter electrode 61.

The present application claims priority to Patent Application No. 2009-116786 filed in Japan on May 13, 2009 and Patent Application No. 2010-6696 filed in Japan on Jan. 15, 2010 under the Paris Convention and provisions of national law in a designated State, the entire contents of which are hereby incorporated by reference.

### EXPLANATION OF REFERENCE NUMERALS

10: active matrix substrate

11, 71: insulating substrate

12: gate bus line

13: Cs bus line

13a, 13b: end portion of Cs bus line

14: gate insulator

15: semiconductor layer

16: source bus line

17: source

18: drain

19: gate

20: TFT

21: gate terminal

22: source terminal

23a, 23b: Cs terminal

24: storage capacitance portion

25a, 25b, 25c, 25d: Cs connection wiring

26: interlayer dielectric

27: inorganic insulating film

28: insulating resin film

29a, 29b, 29c, 29d, 29e, 29f, 29g, 29h, 29i, 29j, 29k, 29m: contact hole

30, 72: vertical alignment film

31: first conductive layer

32: second conductive layer

33: third conductive layer

34: common signal

40: pixel electrode

41: pixel trunk portion

42: pixel branch portion

50: common electrode

51: common boundary portion

52: common branch portion

53: common frame portion

60: liquid crystal layer

61: counter electrode

62: dielectric layer

70: opposed substrate

35, 73: polarizer

35t, 73t: polarizer transmission axis

81: display area

82: rim area

1. A liquid crystal display device, comprising: a first substrate and a second substrate disposed opposing each other; and a liquid crystal layer sandwiched between the first substrate and the second substrate,
wherein the first substrate includes a gate bus line, a source bus line, a pixel electrode to which an image signal is inputted, and a common electrode to which a common signal is inputted,
the pixel electrode and the common electrode are comb-shaped within a pixel,
an electric field parallel to the surface of the first substrate is generated between the pixel electrode and the common electrode within the pixel, and
the common electrode is arranged, within a display area, at a layer that is different from a layer at which the gate bus line is formed and from a layer at which the source bus line is formed.

2. The liquid crystal display device according to claim 1, wherein the common signal is inputted to the display area from at least three directions, along the gate bus line and the source bus line.

3. The liquid crystal display device according to claim 2, wherein the common signal is inputted to the display area from four directions, along the gate bus line and the source bus line.

4. The liquid crystal display device according to claim 1, wherein the display area includes a rectangular shape in a plan view, and
the common signal is inputted to the display area from at least three sides of the display area.

5. The liquid crystal display device according to claim 4, wherein the common signal is inputted to the display area from four sides of the display area.

6. The liquid crystal display device according to claim 1, wherein the common electrode intersects the gate bus line and the source bus line outside the display area.

7. The liquid crystal display device according to claim 1, wherein the common electrode surrounds an entire outer periphery of the display area.

8. The liquid crystal display device according to claim 1, wherein the common electrode includes a boundary portion formed along a boundary between adjacent pixels, and a branch portion extending from the boundary portion into the pixel.

9. The liquid crystal display device according to claim 8, wherein the boundary portion covers the gate bus line and the source bus line.

10. The liquid crystal display device according to claim 1, wherein the common electrode and the pixel electrode are disposed at a same layer within the display area.

11. The liquid crystal display device according to claim 1, wherein the first substrate further includes a storage capacitance wiring, and
the storage capacitance wiring is disposed, within the display area, at a layer different from a layer at which the common electrode is formed.

12. The liquid crystal display device according to claim 11, wherein a signal that is identical to the common signal is inputted to the storage capacitance wiring.

13. The liquid crystal display device according to claim 12, wherein the storage capacitance wiring is connected to the common electrode.

14. The liquid crystal display device according to claim 13, wherein the storage capacitance wiring is connected to the common electrode outside the display area.

15. The liquid crystal display device according to claim 11,
wherein the first substrate further includes a Cs connection wiring formed outside the display area; and
the Cs connection wiring connects one end to another end of the storage capacitance wiring.

16. The liquid crystal display device according to claim 15, wherein the Cs connection wiring is connected to the common electrode outside the display area.

17. The liquid crystal display device according to claim 1, wherein the common electrode is disposed, within the display area, further on the side of the liquid crystal layer than the gate bus line and the source bus line.

18. The liquid crystal display device according to claim 17, wherein the first substrate further includes an interlayer dielectric provided between the layers of the common electrode and of the gate bus line or the source bus line, and the interlayer dielectric includes an insulating resin film.

19. The liquid crystal display device according to claim 18, wherein the insulating resin film contains an acrylic resin.

20. The liquid crystal display device according to claim 18, wherein the insulating resin film is photosensitive.

21. The liquid crystal display device according to claim 18, wherein the relative permittivity of the insulating resin film ranges from 2.7 to 4.5.

22. The liquid crystal display device according to claim 1, wherein the liquid crystal layer includes a p-type nematic liquid crystal.

23. The liquid crystal display device according to claim 22, wherein the p-type nematic liquid crystal is vertically aligned with respect to the surfaces of the first substrate and of the second substrate when no voltage is applied.

24. The liquid crystal display device according to claim 22, wherein the p-type nematic liquid crystal is horizontally aligned with respect to the surfaces of the first substrate and of the second substrate when no voltage is applied.
